(19) United States
(12) Patent Application Publication
(10) Pub. No.: US 2013/0207408 A1
(43) Pub. Date: Aug. 15, 2013

(54) CRASH STRUCTURE WITH ADJUSTABLE RIGIDITY FOR A DEFORMATION ELEMENT FOR A VEHICLE

(71) Applicants: Thomas Friedrich, Freiberg A.N. (DE); Bernd Goetzelmann, Rutesheim (DE)

(72) Inventors: Thomas Friedrich, Freiberg A.N. (DE); Bernd Goetzelmann, Rutesheim (DE)

(73) Assignee: Robert Bosch GmbH, Stuttgart (DE)

(21) Appl. No.: 13/809,308

(22) PCT Filed: May 18, 2011
(86) PCT No.: PCT/EP2011/058060

§ 371 Date: Mar. 29, 2013

(30) Foreign Application Priority Data
Jul. 16, 2010 (DE) 10 2010 031 431.5
Jul. 29, 2010 (DE) 10 2010 038 610.3
Mar. 2, 2011 (DE) 10 2011 004 948.7

(51) Int. Cl. B60R 19/34

(52) U.S. Cl. CPC B60R 19/34
USPC 293/133

(57) ABSTRACT

A crash structure with adjustable rigidity for a deformation element in a vehicle includes an infinitely variably adjustable rigidity. The adjustable rigidity is adjusted by moving two profiles relative to each other such that a position of the two profiles opposite each other is reached. The position defines a degree of rigidity for the deformation element.

### PRIOR ART

The invention relates to a crash structure having adjustable rigidity for a deformation element for a vehicle in accordance with the generic type of the independent claim.

EP 1 792 786 A2 discloses a crash box that comprises a housing-like deformation profile having on the longitudinal chassis beam side a flange plate and said crash box being embodied as a folded construction made from sheet metal plate. The deformation profile comprises two shell components, wherein a flange plate section is formed on each shell component. The shell components are folded from starting plates made from sheet metal, subsequently placed together and joined one to the other by means of resistance spot welding. This represents a conventional crash box without any adaptation to suit a crash incident. However, an adaptation of this type is known by way of example from DE 197 45 656 A1. In this case, an impact absorber is proposed for a motor vehicle, wherein in response to a pre-crash signal, which is a signal from a sensor system that has an all-round view, such as a radar sensor system, or in response to an impact signal, a controlled deformation can be performed. It is proposed that slides move on a deformation element in a perpendicular direction with respect to the direction of force and as a consequence said slides inhibit deformation elements, so that by means of the force effect these deformation elements by means of plastic deformation as a result of the inhibiting action reduce crash energy. It is possible to make an adaptation to suit the crash incident by arranging deformation elements of this type in parallel one with the other or one inside the other. As a further example, it is proposed to use a deformation element in order to reduce crash energy by means of tapering. In so doing, one element is fixed in order for tapering to be carried out and a further element can be released by means of a slide in order to reduce the tapering. The slide is moved in this case in a radial manner, i.e. in a perpendicular manner with respect to the direction of force and consequently with respect to the longitudinal axis of the deformation element, generally a cylinder that has a predetermined wall thickness.

### DISCLOSURE OF THE INVENTION

The crash structure in accordance with the invention having adjustable rigidity for a deformation element for a vehicle having the features of the independent claim has the advantage that now the rigidity can be adjusted continuously, in that two profiled elements are moved one towards the other in such a manner that a position of the two profiled elements is achieved with respect to each other which determines a level of rigidity. Since this movement can be performed in extremely small spaced dispositions, it is consequently possible to adjust the rigidity continuously. This principle in accordance with the invention of continuously adjusting the rigidity can, for example, be applied to the so-called tapering, in which a deformation element is tapered by means of the crash structure. The level of tapering, i.e. the extent of the tapering, can now be performed in a continuous manner. However, other techniques for absorbing crash energy, such as a widening arrangement, can also be used by this invention.

A plurality of possible embodiments that are defined by way of example in the dependent claims can be achieved by means of moving the two profiled elements of the crash structure one towards the other. In particular, as a consequence, a structurally simple and cost-effective solution for adjusting the rigidity is achieved.

The crash structure is a bodywork element that is installed at the front of the vehicle between a longitudinal chassis beam and a crossbeam of the vehicle. This crash structure is provided with an adjustable rigidity in order to be able to react to the respective crash with an appropriate level of rigidity. The function of a crash structure of this type is to protect the longitudinal chassis beam against deformation as a result of the crash up to a predetermined strength. Consequently, the vehicle can subsequently be repaired after the crash with respect to the crash structure. However, a deformation of the longitudinal chassis beam can end in total loss. A crash structure of this type can be provided with a dedicated sensor system and electronic system in order to be able to perform the adaptation of the rigidity. The sensor signals from the sensors that are attached to the crash structure can also be evaluated by a control device outside the crash structure. For example, the air bag control device or the ESP control device or another control device can be used for this purpose. However, it is possible that the crash structure comprises a dedicated control device. This control device can also be located within or outside the crash structure. In this case, conventional acceleration sensors, air pressure sensors, proximity sensors or other appropriate sensors can be used as sensors.

Thus, the rigidity is the level of the mechanical resistance that the crash structure presents to the crash. This resistance can be achieved as mentioned above, for example, by means of tapering a deformation element or by means of a widening or shaving-off arrangement or other structures that convert the crash energy into deformation energy. However, other effects namely, by way of example, a restricting effect are also possible in place of the deformation energy.

Continuously means in this instance that a desired rigidity can be set. This rigidity must be provided within a predetermined range that is defined by the structure. Consequently, a maximum and a minimum rigidity are possible. In order always to be able to react in serious crashes with the maximum rigidity, the normal setting of the crash structure is the maximum rigidity.

The term ‘profiled elements’ could be understood to mean the various structures as they are then also defined in the dependent claims. The profiled elements can be embodied, for example, in a tube-like manner and in particular, as defined in the dependent claims, they comprise a plurality of segments or sections. However, any other form can be subsumed under the term ‘profiled element’. The position of the two profiled elements with respect to each other defines the level of rigidity. In other words, each different position is associated with a different level of rigidity. As is evident from the dependent claims, the orifice, through which a deformation element is driven for the purpose of being tapered, can as a consequence comprise different shapes, in particular different diameters, depending upon the adjustment. The crash structure is embodied in such a manner that any diameter is then possible within the range. It is clear to the person skilled in the art that ‘continuously’ or ‘each level of rigidity’ can also be understood to mean a certain resolution that is predetermined, for example, depending upon the actuator system. The resolution comprises many resolution steps such that it is subsumed for the person skilled in the art under the term ‘continuously’.

The level of rigidity refers to how rigid the crash structure can remain with respect, for example, to a deformation element. The term ‘determine’ can also mean ‘adjust’ or other synonyms.

Advantageous improvements to the crash structure disclosed in the independent claim are possible by means of the features and developments mentioned in the dependent claims.

As mentioned above, the deformation element is advantageously tapered by means of an orifice, wherein the orifice is defined by the two profiled elements and in particular their position with respect to each other. As a consequence, crash energy is converted into deformation energy and in fact as a result of the tapered configuration.

In an advantageous manner, a first of the two profiled elements comprises a tapering structure that comprises at least one air gap which is adjusted by means of the second profiled element. In this case, it is of advantage, for example, that the tapering structure comprises an external structure that adjusts the air gap in cooperation with the second profiled element. In other words, if no air gap remains, then the maximum rigidity is provided and if the maximum area of the air gap is available then the minimum rigidity is provided. However, it is not absolutely necessary to provide the air gap. When the tube that is to be tapered is already lying against the first profiled element (that of the tapering) and the tapering has already commenced, but then the inhibiting ring is displaced, the die element moves simultaneously, so that constant contact is provided between the inhibiting ring and the die segment and between the die segment and the tube. Despite this, the rigidity is varied.

It is advantageous that the second profiled element is embodied in an annular manner in order for it to be arranged over the tapering structure and then the respective rigidity is defined depending upon the position of this inhibiting ring with respect to the tapering structure.

Advantageously, this tapering structure can comprise a plurality of segments, wherein these segments are held together by means of at least one spring, in particular a flexible spring. The segments can, for example, in the case of minimum rigidity form a concentric orifice and in the case of maximum rigidity form a square orifice with curved edges.

It can, however, also be precisely the reverse, so that in the case of tapering with a comparatively lower level of rigidity, in certain circumstances, longitudinal grooves form in the tube. Energy is then in addition converted by means of shaving procedures.

When the tapering structure is embodied from a plurality of segments, it can comprise predetermined breaking points in order to break by means of the deformation element in each case depending upon the position of the tapering structure with respect to the second profiled element and consequently to define the orifice.

The external structure can comprise a curved path or at least an incline that determines the rigidity in cooperation with the second profiled element. Consequently, it is then clear that, even if the ring always comprises the same diameter and consequently does not exert any force on the tapering structure, by means of the deformation element as it drives through the tapering structure, the tapering structure is still bridged with respect to the inhibiting ring as the second profiled element and thus the rigidity is set.

This inhibiting ring as the second profiled element can also comprise a plurality of segments that are now referred to as inhibiting elements and that correspond to the respective segments of the tapering structure.

Exemplary embodiments of the invention are illustrated in the drawing and explained in detail in the following description.

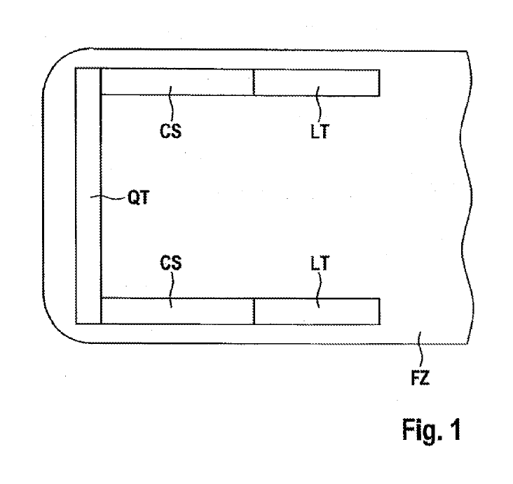

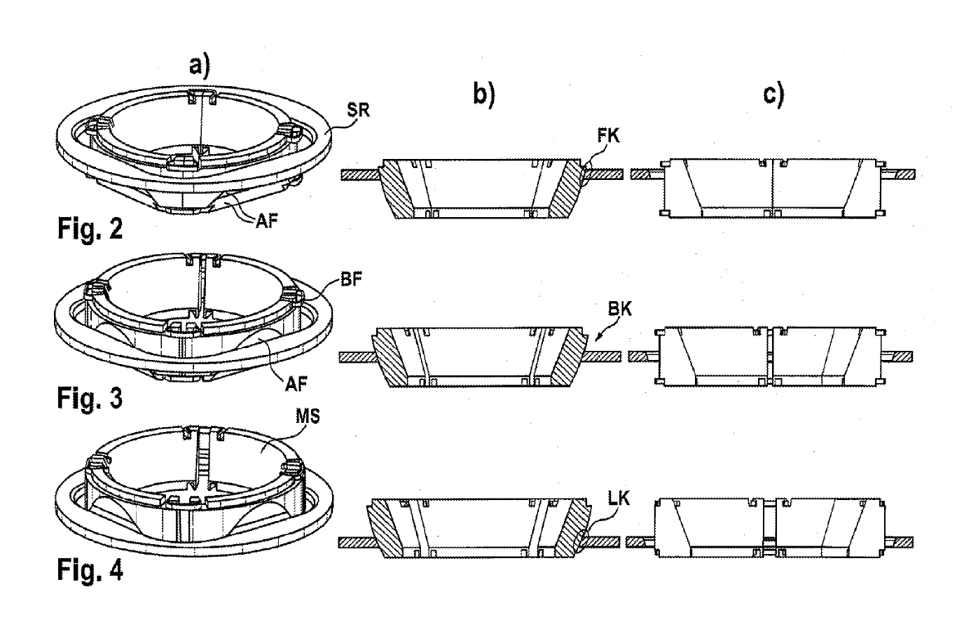

FIG. 1 illustrates schematically where the crash structure is installed in the vehicle. FIGS. 2 to 4 illustrate the tapering structure with an inhibiting ring in an inclined view and two cross-sectional views rotated by the angle of 45° with respect to each other.

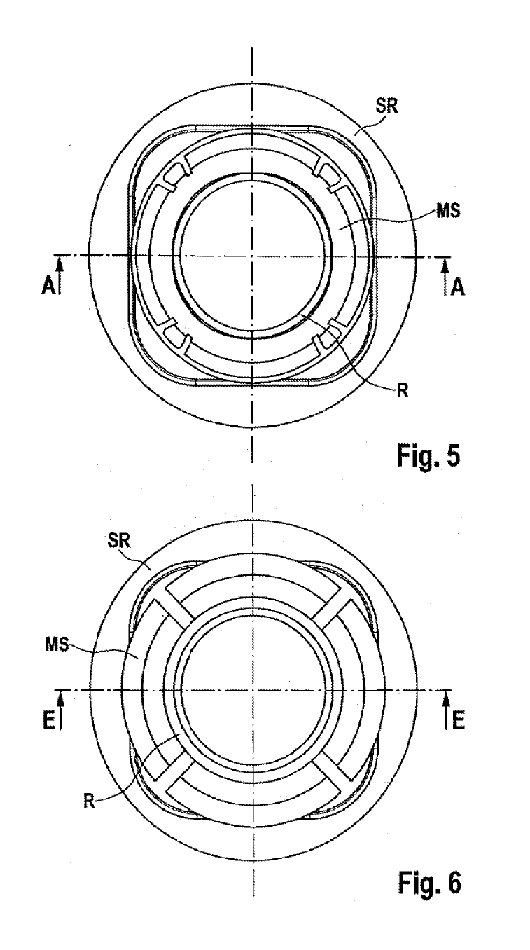

FIG. 5 illustrates a plan view of the tapering structure with an inhibiting ring in the case of maximum rigidity and

FIG. 6 in the case of minimum rigidity.

FIG. 1 illustrates schematically where the crash structure CS is installed in the vehicle FZ. The crash structure CS is located respectively between a crossbeam QT and the respective longitudinal chassis beams LT. As disclosed above, the present relevant function of the crash structure CS is to protect the longitudinal chassis beam LT in the best possible manner prior to many crashes in order to avoid deformation of this longitudinal chassis beam LT and thus to prevent a total loss of the vehicle FZ. The most important function is, however, to protect the occupants of the vehicle, whilst a further optional function is to protect pedestrians. In accordance with the invention, the crash structures comprise a continuously adjustable rigidity.

FIGS. 2 to 4 illustrate the shaping of the tapering as deformation in the gaps a, b and c for different levels of rigidity; a view of the tapering structure with an inhibiting ring, b a cross-sectional view through the tapering structure with an inhibiting ring and c a cross-sectional view that has been rotated with respect to the cross-sectional view b by 45°. In accordance with the invention, in this case the continuously adjustable tapering is performed by means of displacing an inhibiting ring SR in an axially parallel manner with respect to the tapering structure or die plates. FIGS. 2 to 4 illustrate an exemplary embodiment having four die segments MS and eight flexible springs BF that hold together the die segments MS. In place of eight springs of this type, it is also possible for this purpose to use fewer or in particular only one spring. A variant is illustrated here that can in principle also be adjusted while a crash is in progress.

FIGS. 2 to 4 illustrate three different positions of the inhibiting element SR and consequently a corresponding setting of rigidity: in FIG. 2 a rigid setting, in FIG. 3 a middle setting and in FIG. 4 the least rigid setting. Any other position is, however, likewise possible. The support of the die segments MR is achieved in the illustrated variant in such a manner that supporting surfaces AF are provided on the die segment MS, which supporting surfaces are curved in one plane in such a manner that in the case of the most rigid setting of the inhibiting ring, the inhibiting ring SR lies against the die segments MS at the top as illustrated in FIG. 2. In the case of all other positions of the inhibiting ring SR, linear contact is initially created during the course of the crash at these contact sites, which linear contact can then become two-dimensional by means of the elastic or also plastic changes in shape of the components. The curvature is therefore advantageous because as a consequence the adjusting times are reduced. The angle of the curved path can be optimized at each site in such a manner that the frictional forces during a crash are in fact sufficiently high that the inhibiting ring SR is fixedly held in the desired position but the adjusting path of the inhibiting ring SR is nonetheless kept small. It is also possible to provide a convex contact surface on the die segments MS, so that in fact spot contacts can occur but no edge supports occur. If the friction between the inhibiting ring and the die segment is small and/or the angle large, an actuator system or another mechanism must hold the inhibiting ring in position. FIGS. 2 to 4 illustrate an inhibiting ring that supports all the die segments in the same position. It is also feasible for each die segment individually to use an inhibiting element. The two-dimensional contact is indicated by FK, the curved path by BK and the linear contact by LK in FIGS. 2 to 4.

FIGS. 5 and 6 illustrate the die segments MS with the inhibiting ring SR and the deformation element R in the case of the most rigid setting of the adaptive crash structure CS in FIG. 5, and in the case of the least rigid setting of the adaptive crash structure CS in FIG. 6. The die segments were predominantly embodied in such a manner that their internal diameter is concentric in the case of the least rigid setting of the adaptive crash structure. In the case of a more rigid setting, the die segments are displaced inwards until they lie one against the other in the case of the most rigid setting. As a consequence, the internal diameters form a type of square with curved corners. During the tapering, the tube R assumes its tube-shaped cross-section in an intermediate shape between a round tube and a square tube. No edge indentions occur. If the internal diameter of the die segments MS in the case of the most rigid setting of the adaptive crash structure were to be concentric, then the edges of the die segments in the case of the least rigid setting would dig into the tube. This does not necessarily have to be disadvantageous, if the portion of the crash energy formed by the grooves is reduced in a controlled manner.

It is also possible to produce the tapering structure from one piece with predetermined breaking points. The springs could then be omitted. The number of die segments in both directions can also be adjusted. The cross-sectional view of FIGS. 2b to 4b is taken at AA and/or EE and the cross-sectional view of FIGS. 2c to 4c is taken at BB and/or FF.

1. A crash structure having adjustable rigidity for a deformation element for a vehicle, comprising:
two profiled elements configured to move toward each other to achieve a position of the two profiled elements with respect to each other, wherein:
the position determines a level of rigidity, and
the level of rigidity is continuously adjustable.

2. The crash structure as claimed in claim 1, wherein the deformation element is tapered by an orifice that is defined by the two profiled elements to convert crash energy into deformation energy.

3. The crash structure as claimed in claim 2, wherein a first profiled element of the two profiled elements is a tapering structure including at least one air gap which is adjusted by a second profiled element of the two profiled elements.

4. The crash structure as claimed in claim 3, characterized in that wherein the tapering structure comprises includes an external structure that adjusts configured to adjust the at least one air gap in cooperation with the second profiled element.

5. The crash structure as claimed in claim 3, wherein the second profiled element is annularly shaped.

6. The crash structure as claimed in claim 3, wherein the tapering structure includes a plurality of segments that are held together by at least one spring.

7. The crash structure as claimed in claim 6, wherein the plurality of segments form a concentric orifice when the level of rigidity is at a minimum and form a square orifice with curved edges when the level of rigidity is at a maximum.

8. The crash structure as claimed in claim 3, wherein:
the tapering structure includes a plurality of segments and has predetermined breaking points,
a position of the tapering structure with respect to the second profiled element enables the tapering structure to be broken by the deformation element, and
the position of the tapering structure with respect to the second profiled element enables the tapering structure to define the orifice.

9. The crash structure as claimed in claim 4, wherein the external structure includes one of a curved path and an incline configured to determine the level of rigidity in cooperation with the second profiled element.

10. The crash structure as claimed in claim 6, wherein the second profiled element includes inhibiting elements that correspond to the segments in the plurality of segments.
